(19) United States
(12) Patent Application Publication
(10) Pub. No.: US 2023/0337634 A1
(43) Pub. Date: Oct. 26, 2023

(54) ENVIRONMENTALLY FRIENDLY ANIMAL WASTE BAG

(71) Applicant: Antonio Eduardo Baggio, Belo Horizonte (BR)

(72) Inventor: Antonio Eduardo Baggio, Belo Horizonte (BR)

(21) Appl. No.: 17/729,341

(22) Filed: Apr. 26, 2022

(51) Int. Cl. A01K 23/00; B65D 30/08; B65D 30/20; B65D 33/06

(52) U.S. Cl. CPC A01K 23/005; B65D 31/02; B65D 31/10; B65D 33/06

(57) ABSTRACT

The renewable, biodegradable, and compostable waste manure bag made from virgin or recycled kraft paper specially designed for the collection of animal waste, such as domestic dogs, will allow the user quickly and easily collect and dispose the pet waste. The waste bag has an innovative design and is environmentally friendly. Further, the waste bag has a feature promoting its closure as to isolate the pathogens for better waste management, containing in its formulation a variety of reagents on its inner surface to neutralize pathogens and aromas. The same material can accelerate the composting and reintegration into the soil.

### COPYRIGHT NOTICE

A portion of the disclose of this patent document contains material that is subject to copyright protection. The copyright owner has no objection to the facsimile reproduction by anyone of the patent document or the patent disclosure, as it appears in the Patent and Trademark Office patent file or records, but otherwise reserves all copyright rights whatsoever.

### BACKGROUND OF THE INVENTION

The following includes information that may be useful in understanding the present invention. It is not as admission that any of the information provided herein is prior art, or material, to the presently described or claimed invention, or that any publication or document that is specifically or implicitly is prior art.

### 1. FIELD OF THE INVENTION

The present invention relates generally to the field of animal waste receptacles. More specifically, the invention is an environmentally friendly animal waste bag which is renewable, biodegradable, and compostable waste manure bag made from virgin or recycled kraft paper specially designed for the collection of animal waste, such as domestic dogs and pets in general. It is intended to be produced by the paper packing industry.

### 2. DESCRIPTION OF THE RELATED ART

In the present state of the art there are many pets that are bred and kept by humans. The numbers are significant. All these pets generate waste that needs to be disposed properly. Owners of such pets are usually required to manage their waste, no always disposing of it properly. Pet waste presupposes a hazard and cannot be composted without the due care.

The problem with pet waste is huge and is present everywhere. The numbers speak tremendously and call for a solution to the growing issue. It is relevant to take care of water pollution, to the food contamination and so on. Eighty percent of humans may be infected—to some degree—with animal bacteria such as Helicobacter pylori and similar others. Worms are also a major threat and are a very common form of infection that comes from animal waste that is disposed of in the environment.

Most metropolises have legislation imposing fines for non-collection of animal droppings in public places. Eighty million dogs currently live in the United States and about 54 million in Brazil and they generate around 30 and 20 million tons of waste per year respectively, of which about ⅓ million tons of dog waste are discarded or left in the environment every year. The average dog defecates between ¼ and about ¾ of one kilo of manure per day, which amounts to 91 to 274 kg per year by a single individual pet. Only about 60% of dog owners collect their pet's waste, the remainder being left in the environment. This estimate scenario does not compute the waste of other pets than dogs.

Animal feces pose a major threat to public health because they can transmit several vectors. Animal waste is a major cause of water pollution, and this pollution poses a significant risk to human health. The US Environmental Protection Agency confirms that pet waste is a significant cause of water body contamination in areas where there is a high housing concentration. The main risk present in animal waste is roundworms. Animals can host a myriad of vectors in the form of viruses, bacteria and parasites, including harmful pathogens such as Escherichia coli, Giardia lamblia and Salmonella spp. A single gram of feces can contain about 23 million bacteria. Studies have shown that 20-30% of bacteria in urban basin water samples come from animal waste. Diseases such as Heartworms, Corona, Giardiasis, Salmonellosis, Cryptosporidiosis, Campylobacteriosis, Parvo, Whipworms, Hookworms, Roundworms and Tapeworms may be transmitted by contact with fecal matter, according to the US Center for Disease Control and Zoonosis.

When the waste of an infected animal is deposited on the ground, likely on the squares and plazas where they are brought to hang or on the sand of the beaches, the eggs of certain pathogens and other parasites can lie dormant in these soils for years. Any human or animal that meets that soil runs the risk of contaminating with these eggs, giving life to the contamination cycle. Fecal Streptococcus and fecal coliforms are just two of these examples. In sufficiently large quantities, these bacteria can make people very sick, causing gastrointestinal infections, ear, eye and throat infections. Campylobacter may cause diarrhea. Salmonella can cause infections and fever, muscle aches, headaches, vomiting and diarrhea.

There are bags for collecting feces available and there is a reasonable market demand for animal waste collection bags. In particular, environmentally friendly solutions desired by the environmentally conscious community rather than ordinary plastic bags. There are several models of various materials, some made of paper and most of plastic, but few of renewable and biodegradable origin. However, none have any kind of an efficient sealing device or any special treatment in the lining waste. The overwhelming majority of such bags being non-biodegradable or non-compostable plastic bags.

Currently, there are some bags made of oxygen-biodegradable materials that degrade themselves after they are disposed in dumps or even in landfills, but they leave residues and contaminants resulting from its cracking. Its decomposition is not instantaneous, but rather fragmented, due to the molecular structure of plastic, which is still contaminating the soil.

There are no solutions in the State of the Art to carry animal waste in the form of special bags that can make it safe to throw it away or to dispense in the toilet. Further, in the present State of the Art, no bag model that is made of biodegradable and compostable material has a device to block the air diffusion and odors as well as the passage of various pathogens during its handling or collection and disposal of the waste bag. A bag that is recyclable and intentionally made to avoid the dispersal f bacteria in the environment and the consequent contamination of beings around them, even during the stage of biodegradation of these wastes is not found everywhere.

Problems with the State of the Art are mainly linked to the fact that plastic bags of any kind take a long time to deteriorate in the environment and leave residues for a long time. Among the existing options in the State of the Art, the t-shirt type plastic bag with its lateral straps that are to be tied to each other as to get it sealed is the main and most used way to collect animal waste in these modern times of today. In the United States of America, the State of California considers passing the first ban on the use for plastic bags for this purpose. This ban will make it the most worrying problem, since today there is a lack of other forms of collection and disposal of animal waste rather than plastic bags.

The contamination of the environment by pathogens and of the soil by contaminating residues of plastics degradation is a great worry. This reality has become a concern, whose solution or mitigation is being delayed worldwide and not otherwise in Brazil. This problem has helped to create and maintain a market for biodegradable animal waste bags. The market leader BioBags sells over 50 million bags per year. These bags are designed to be composted and not dispensed in dumpsters. In the absence of composting programs, most bags full of waste end up in dumps and landfills, where they are mode likely to degrade than an ordinary plastic bag. A compostable manure bag that degrades under the circumstances of landfills produces methane thar is released freely into the atmosphere, increasing air pollution and the greenhouse effect, yet releasing pathogens and bacteria into the soil and in the environment.

The most common way to get rid of a dog's waste is to put it in a plastic bag and throw it in the trash or unload the contents of the bag into the toilet. Flushing may be an option. However, it would be only transferring the problem to the company that treats the municipal sewage. Therefore, one special bag model with the necessary features and attributes to be safe for either being discarded or composted into manure without chemical residue from the bag material was develop and claimed in this highly innovative invention.

### BRIEF SUMMARY OF THE INVENTION

The solution presented here, the ENVIRONMENTALLY

FRIENDLY DISPOSABLE WASTE BAG manner to be fully compostable that may be produce from virgin or recycled paper and as to have a feature or device for promoting its closure to isolate the pathogens for better animal waste management, which can contain in its formulation a variety of reagents on its inner surface to neutralize pathogens and aromas and to more timely achieve composting and reintegration into the soil

A paper bag made according to the method descried for building an ENVIRONMENTALLY FRIENDLY DISPOSABLE WASTE BAG can be salad with the help of its handles that have a locking feature, making the contents of the waste better isolated from the outside. The resulting package and contained waste can be safely disposed of or added to the compost to be biologically composted in a timely manner and to be better integrated to the soil and atmosphere, without leaving chemical residues.

### BRIEF DESCRIPTION OF THE DRAWINGS

The ENVIRONMENTALLY FRIENDLY DISPOSABLE WASTE BAG is further shown together with the drawings which are schematic in nature and are not intended to limit the possibilities in the constriction that may vary in shape and form but yet retain the original novelty presented in the disclosed concept.

The drawings represent the ideal variant, or the preferable build of the invention. They show the ideal variant and manner of forming the concept and the proposed methodology of application, where the peculiarities and details necessary for its realization are shown. They can then be better understood by referring to these accompanying figures and this descriptive report, which represents the preferred embodiment of the invention, but which shall not restrict the scope to their specific configurations as to the dimensions or materials presented, nor in proportions, nor in shape, of its elements or order and not even in the eventual types of finishes implement, either in the composition of materials or any modifications inserted in the scope of its practical application that may vary, but that does not hinder the present statements, where the specific explanations of each drawing is disposed as follows.

FIG. 1 is a perspective view of a bag (1) in the preferred embodiment, a variant of the ENVIRONMENTALLY FRIENDLY DISPOSABLE WASTE BAG showing its silhouette and some of its elements.

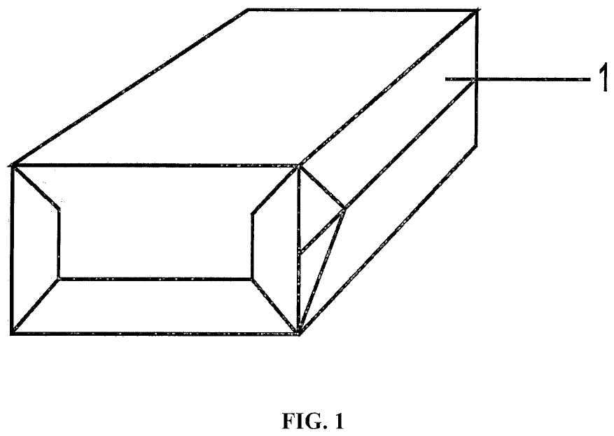

FIG. 2 depicts that embodiment of the ENVIRONMENTALLY FRIENDLY DISPOSABLE WASTE BAG in a similar way showed in FIG. 1, representing the bag (1).

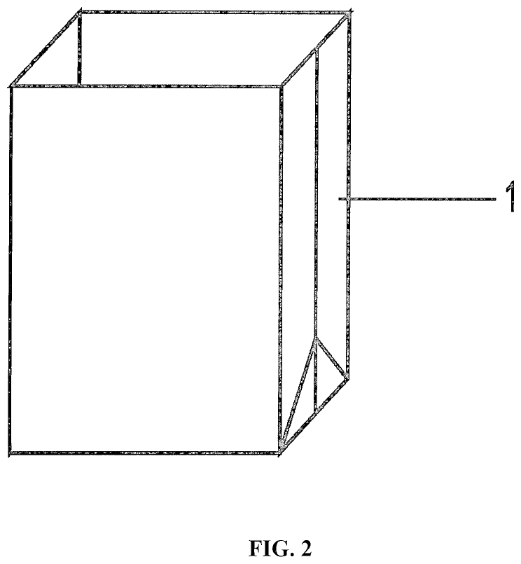

FIG. 3 is a part that is a handle (2) to be attached in the main bag (1) disposed in the ENVIRONMENTALLY FRIENDLY DISPOSABLE WASTE BAG that is formed in the stamping process, showing a perspective of the cuts in the same stamping process for forming the handle (2).

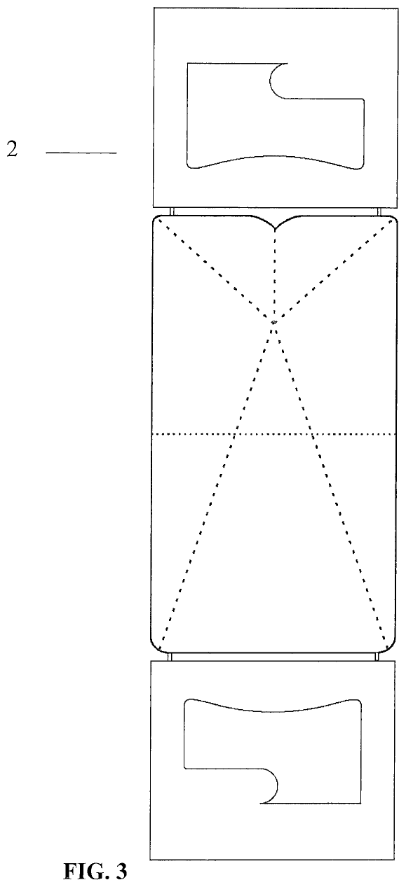

FIG. 4, shows how to frame, from the illustrations showed in FIG. 3 the handle (2) part, initiating from (a) to (b).

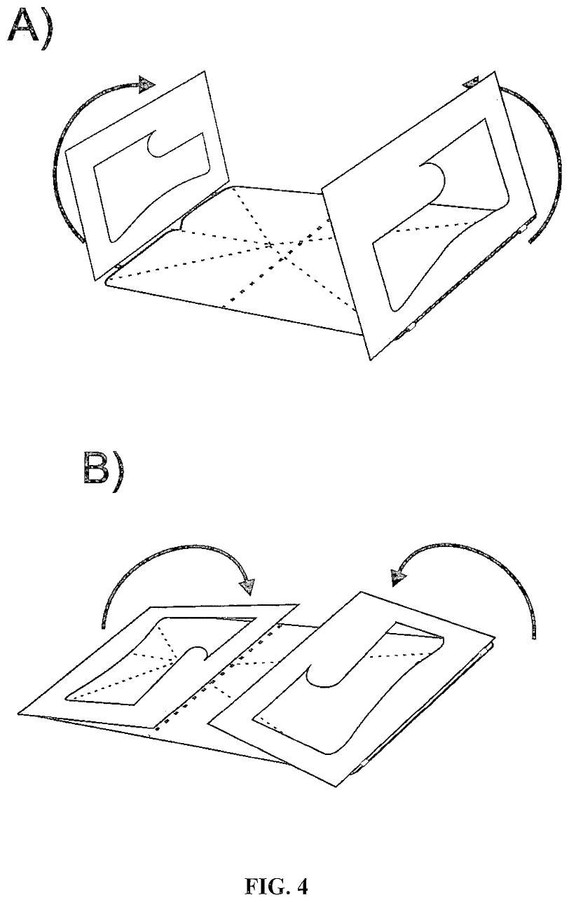

FIG. 5 represents the disposable animal waste bag, where the handle (2) is glued in the bag (1), using the glue line (LC).

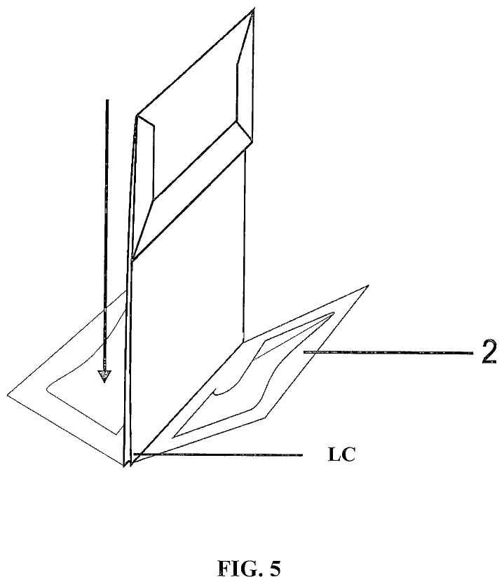

FIG. 6 represents how the friendly disposable animal waste bag can be storage.

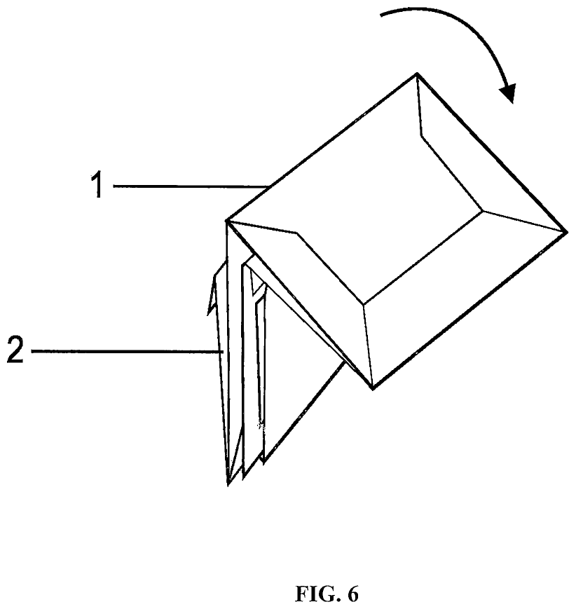

FIG. 7, represents the detail of the shovel (3).

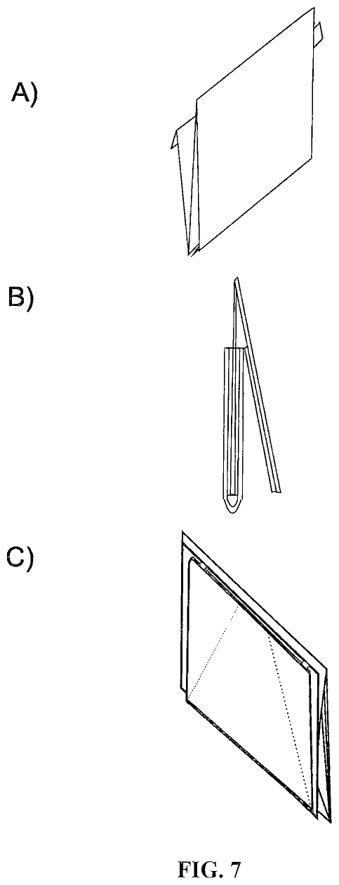

FIG. 8 represents the detail of the shovel (3) inserted in the bag (1) linked to the handle (2).

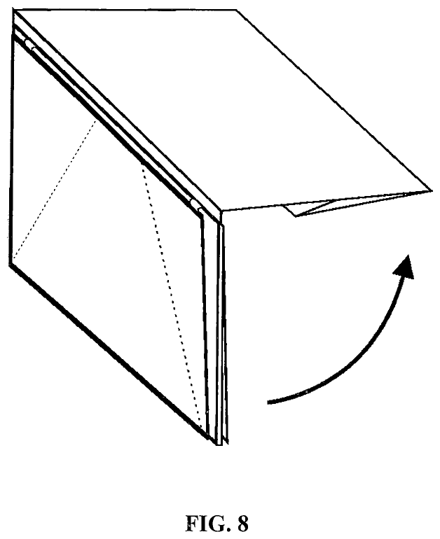

FIG. 9 represents the preferred embodiment of the animal waste bag detached from the handles and the shovel (3) in (a), followed by the illustrations of how to build the whole shovel (3) to be used for collecting the waste (b and c).

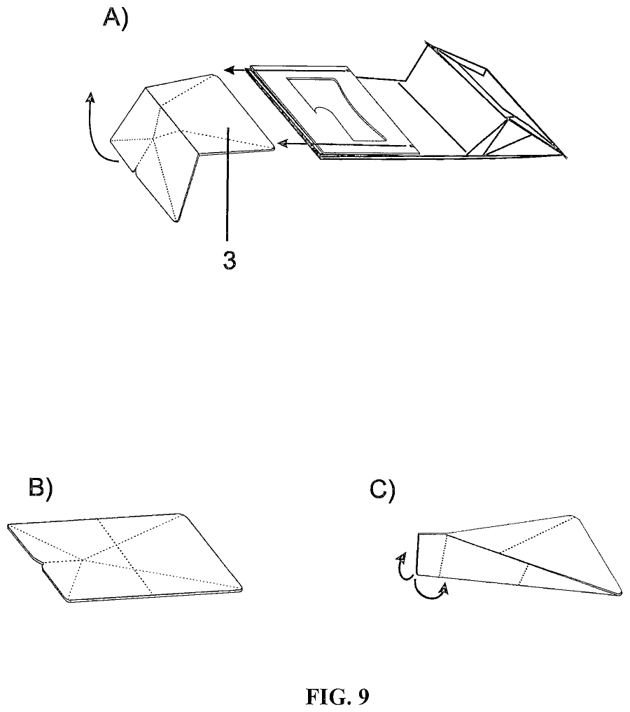

FIG. 10 shows all the parts of the Environmentally Friendly Disposable Waste Bag, indicating details of the handle (2), which are the connection between the handle and the bag (4) and the apparatus (5) for closing the bag.

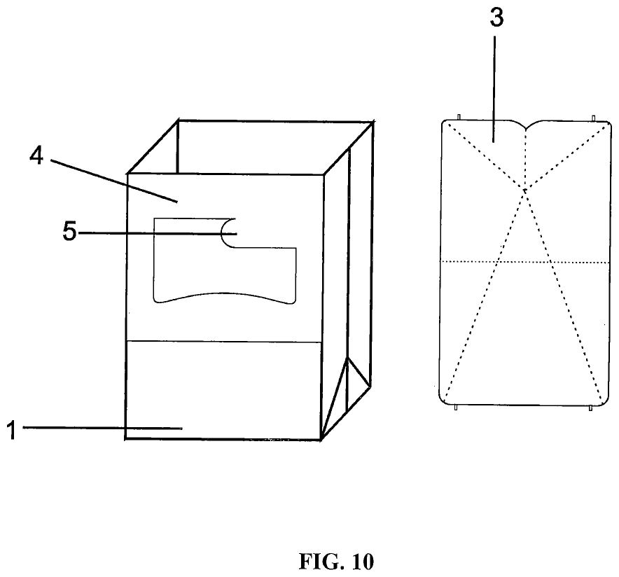

FIG. 11 demonstrates how to open the mounted structure of the whole animal waste bag, starting from (a) to (c).

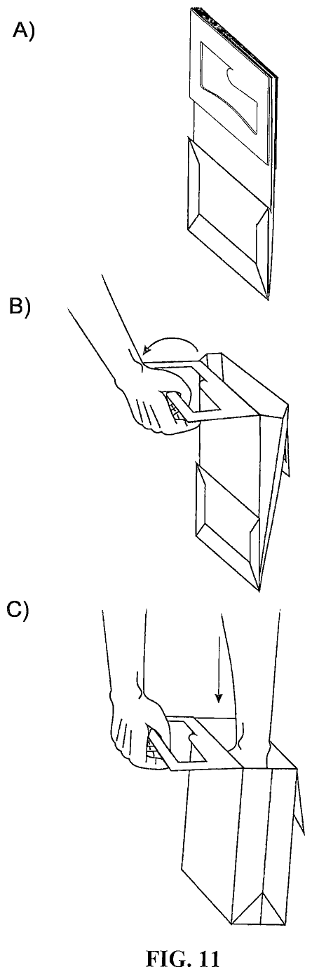

FIG. 12 shows the mechanism for opening the Environmentally Friendly Disposable Waste Bag using one hand only, starting from (a) to (d).

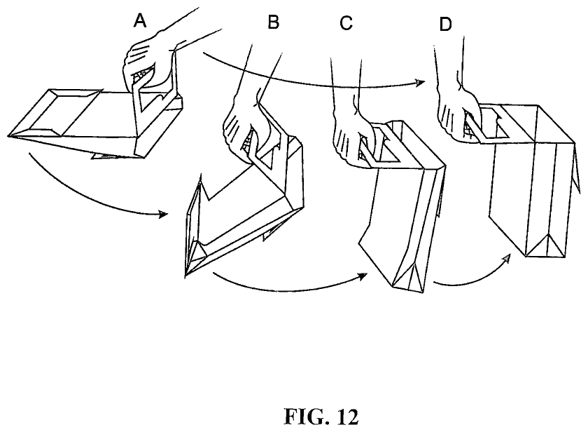

FIG. 13 illustrates the use of the shovel for collecting the waste from (a) to (b).

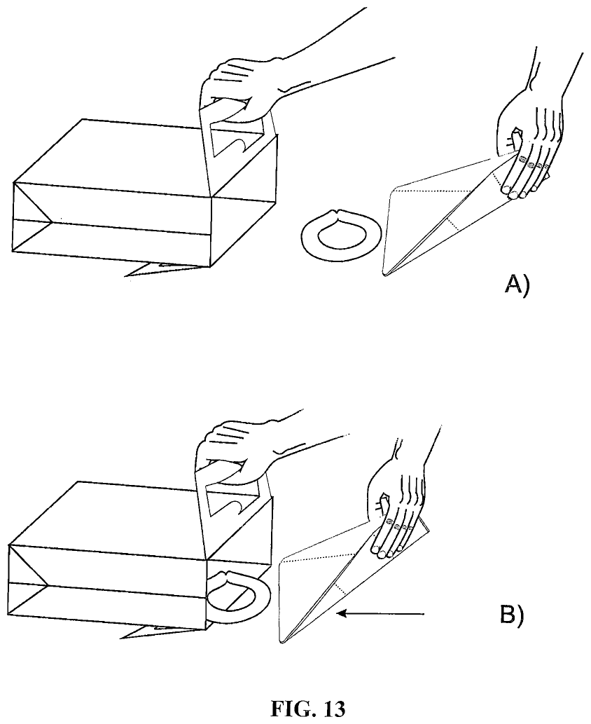

FIG. 14 shows the beginning of the process for the closure of the Environmentally Friendly Disposable Waste Bag, putting together both sides of the handle, from (a) to (b).

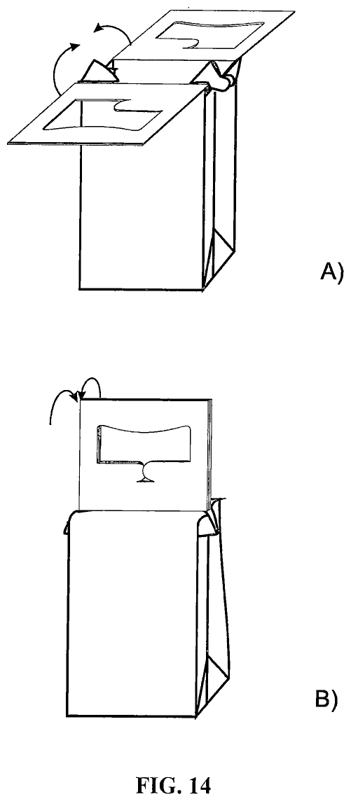

FIG. 15 shows the detail of the closure system, illustrating the specific mechanism for obtaining the closure of the Environmentally Friendly Disposable Waste Bag.

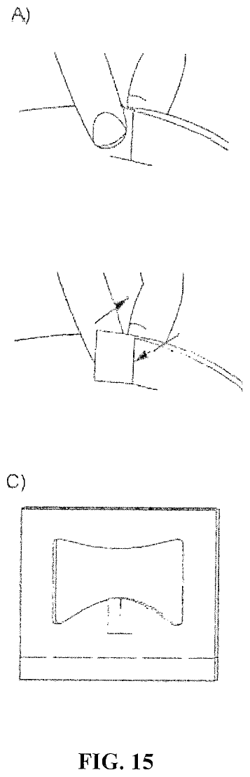

FIG. 16 is a whole overview of the Friendly Disposable Waste Bag perfectly closed.

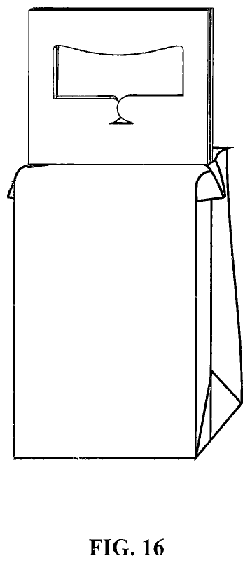

### DETAILED DESCRIPTION

ENVIRONMENTALLY FRIENDLY DISPOSABLE WASTE BAG that comprises a one-piece, disposable, closeable or sealable composite paper bag that is designed for the handling, collecting, and disposing of pet waste. It can contain a variety of 100% biological or chemical reactants in the form of resins applied on its inner surface and is a bag that can be sealed by joining its handles, making the contents isolated from the outside.

The resulting bag and waste contained therein can be safely disposed of or added to the compound to be fully and biologically transformed.

The ENVIRONMENTALLY FRIENDLY DISPOSABLE WASTE BAG has a way of being shaped after an unfolding piece of cardboard forming a pair of locking handles with the highlight of a conformable shovel that is detachable. It can be made from virgin paper or card stock or of recycled materials to achieve 100% biological, biodegradable, and compostable set. The reactants in the resinous films are designed to adequately contain and neutralize the content or animal waste that can subsequently be more properly composted or reintegrated into the soil.

The presently described invention is called ENVIRONMENTALLY FRIENDLY DISPOSABLE WASTE BAG and is formed in a manner that results in design that has a folding handle and a shovel that can be detached from the handles themselves, the closures, and the handle proper, the set being comprised of handles, the shovel, and the bag itself. It is intended to provide an environmentally friendly animal waste collector consisting of paper and paperboard with 100% biodegradable and compostable multilayer coatings or films. The paper layer material may be composed of more than one virgin or recycled, compostable layer which will aim to make the paper waterproof and additionally provide a reactant or containment function as to interact with the feces or waste material contained within the bag, biologically neutralizing the content and its odor.

The outer layer of the bag made in accordance with the current ENVIRONMENTALLY FRIENDLY DISPOSABLE WASTE BAG may contain a protective film or resin that is 100% biodegradable or that is obtained by means of coating pore closure rollers, mitigating odor permeability and providing transient impermeability to the material. The inner layer or layers may consist of a porous or nonporous laminated paper or can be coated with special resins that are impregnated with bactericidal biological products.

The set that completes the ideal constructive variant of the ENVIRONMENTALLY FRIENDLY DISPOSABLE WASTE BAG is suitable for the collection, transport, disposal, or the composting, but may also be disposed of—preferable not—by flushing down the toilet and may effectively help to reduce or eliminate the contaminating animal waste and its reflections of environmental pollution.

The ENVIRONMENTALLY FRIENDLY DISPOSABLE WASTE BAG is ideally made of from 100% renewable (cellulose), 100% recyclable, 100% biodegradable and 100% compostable materials and when used and disposed of correctly, 100% composted material ready for use as fertilizer.

What is claimed is new and desired to be protected by Letters Patent is set forth in the appended claims:

1. ENVIRONMENTALLY FRIENDLY DISPOSABLE WASTE BAG comprising a bag (1) for the collection and the disposal or the composting of animal waste, made of paper or paperboard, wherein there are disposed sealing components that are shaped and glued in the bag forming handles (2), having an attached and detached folding piece of hardened cardboard mode in layered material that is etched in its handle, said handle deriving a shovel (3) when detached and formed or folded; and having a locking system (4 and 5) being obtained by to matching cuts and creases or holes in the piece of cardboard when connected the opposite sides of such a handle, or when said handles are folded in half.

2. ENVIRONMENTALLY FRIENDLY DISPOSABLE WASTE BAG as claimed in claim 1, wherein the sealing components comprises two separate and matching cuts that are printed or etched in the handles (2), said cuts acting as a locking set that aims to seal the bag by locking its sides and ensuring that the bag remains closed.

3. ENVIRONMENTALLY FRIENDLY DISPOSABLE WASTE BAG as claimed in claim 1, wherein the pair of handles has a permanent seal for the contexts of the bag that makes use of adhesive strips printed or glued along the cutting of the locks that fix the same to make bag sealed.

4. ENVIRONMENTALLY FRIENDLY DISPOSABLE WASTE BAG, as claimed in claim 1, wherein the bag is made for containing and conditioning pet waste before disposal and its innermost layer or film is made of material that can be treated with and or carry reagents or reactants to react with its contents and that may contain one or more biologically or chemically active reactant substances for neutralizing bacteria and other pathogens present in the content, said layer being bactericide and suitable.
